(19) United States
(12) Patent Application Publication
(10) Pub. No.: US 2020/0102840 A1
(43) Pub. Date: Apr. 2, 2020

(54) TURBINE BLADE

(71) Applicant: DOOSAN HEAVY INDUSTRIES & CONSTRUCTION CO., LTD., Changwon-si (KR)

(72) Inventor: Jin Ho Bae, Gimhae-si (KR)

(21) Appl. No.: 16/559,604

(22) Filed: Sep. 3, 2019

(30) Foreign Application Priority Data
Oct. 1, 2018 (KR) 10-2018-0117156

(51) Int. Cl. F01D 5/18

(52) U.S. Cl. CPC F01D 5/187; F05D 2240/301; F05D 2250/512; F05D 2250/15; F05D 2260/2212

(57) ABSTRACT

A turbine blade is provided. The turbine blade may include: a cooling passage configured to be defined by a partition wall which partitions an internal area of the turbine blade; and an inlet passage extending from a root part of the turbine blade toward a platform part of the turbine blade and configured to supply cooling air into the cooling passage, wherein an inclined part having a diameter reduced from the root part toward the platform part is formed in the inlet passage.

### CROSS-REFERENCE TO RELATED APPLICATION

This application claims priority to Korean Patent Application No. 10-2018-0117156, filed on Oct. 1, 2018, the disclosure of which is incorporated herein by reference in its entirety.

### BACKGROUND

### Field

Apparatuses and methods consistent with exemplary embodiments relate to a turbine blade, and more particularly, to a turbine blade having an internal structure improved to minimize loss of cooling air to be supplied into a cooling passage.

### Description of the Related Art

A gas turbine is a combustion engine that mixes air compressed in a compressor with fuel for combustion and rotates a turbine using high-temperature and high-pressure combustion gas generated by the combustion.

The turbine includes a configuration in which a plurality of turbine rotor disks each having a plurality of turbine blades on an outer circumferential surface thereof are arranged in a multi-stage structure to pass high-temperature and high-pressure combustion gas through the turbine blades.

However, as the temperature of an outlet of a combustor is gradually increased according to an increase in size and efficiency of gas turbines, a turbine blade cooling unit has been employed to enable the turbine blades to resist to high-temperature combustion gas.

For example, there has been widely known a configuration in which a predetermined cooling channel through which cooling air can flow is provided in a turbine blade, and compressed air supplied from a compressor rotor flows through the cooling channel to use the compressed air as cooling air.

The gas turbine includes a compressor, a combustor, a turbine, and a rotor. The compressor includes a plurality of compressor vanes and a plurality of compressor blades which are alternately arranged.

The combustor is configured to supply fuel to air compressed by the compressor and ignite the fuel mixture using a burner, thus generating high-temperature and high-pressure combustion gas.

The turbine includes a plurality of turbine vanes and a plurality of turbine blades which are alternately arranged. The rotor is configured to pass through central portions of the compressor, the combustor, and the turbine. Opposite ends of the rotor is rotatably supported by bearings, and one end thereof is coupled to a driving shaft of a generator.

The rotor includes a plurality of compressor rotor disks coupled to the compressor blades, a plurality of turbine disks coupled to the turbine blades, and a torque tube configured to transmit rotating force from the turbine disks to the compressor disks.

In the gas turbine, air compressed by the compressor is mixed with fuel and combusted in the combustor, and then is converted into high-temperature combustion gas which is discharged toward the turbine. The discharged combustion gas passes through the turbine blades and generates rotating force to rotate the rotor.

The gas turbine does not have a reciprocating component such as a piston in a four-stroke engine. Because the gas turbine has no mutual friction parts such as a piston and a cylinder, there are advantages in that there is little consumption of lubricant, an amplitude of vibration as a characteristic of a reciprocating machine is greatly reduced, and high-speed operation is possible.

In the conventional gas turbine, a root part is formed in a lower portion of the turbine blade, and an inlet passage into which cooling air is drawn is formed in the root part. A cooling passage through which cooling air flows along an internal area partitioned by a partition wall is formed in the turbine blade.

The inlet passage has a hollow cylindrical shape with a constant diameter and is problematic in that flow rate loss occurs when cooling air passes through a platform. In the conventional turbine blade, because cooling air is drawn into the cooling passage through the inlet passage, if flow rate loss occurs in the inlet passage, the efficiency of cooling the turbine blade is reduced.

### SUMMARY

Aspects of one or more exemplary embodiments provide a turbine blade capable of solving problems occurring due to flow rate loss by improving a structure of an internal inlet passage of a root part into which cooling air is drawn.

Aspects of one or more exemplary embodiments provide a turbine blade capable of supplying cooling air into a cooling passage such that the flow of cooling air through the cooling passage can remain stable.

Additional aspects will be set forth in part in the description which follows and, in part, will become apparent from the description, or may be learned by practice of the exemplary embodiments.

According to an aspect of an exemplary embodiment, there is provided a turbine blade including: a cooling passage configured to be defined by a partition wall which partitions an internal area of the turbine blade; and an inlet passage extending from a root part of the turbine blade toward a platform part of the turbine blade and configured to supply cooling air into the cooling passage, wherein an inclined part having a diameter reduced from the root part toward the platform part may be formed in the inlet passage.

The turbine blade may further include a leading edge formed on a front end of the turbine blade so that the leading edge first comes into contact with hot gas and a trailing edge formed on a rear end of the turbine blade. The inlet passage may include a first inlet passage formed at one side based on the partition wall in a cross-sectional view of the root part and a second inlet passage formed at the other side based on the partition wall.

The inlet passage may include a single first inlet passage and a plurality of second inlet passages.

The second inlet passage may extend a length greater than a length of the first inlet passage in a lateral direction.

The plurality of second inlet passages may have different sizes.

The inlet passage may have a width (W) extending in a horizontal direction and a length (L) extending in a vertical direction, and the width (W) may be greater than the length (L).

The inclined part may be inclined at an angle of 45° or less.

A guide rib protruding outward may be provided on the inclined part to allow the cooling air to form vortexes while moving in a flow direction.

The guide rib may be spirally wound along an inner surface of the inclined part.

An opening hole that is open toward the cooling passage may be formed in the guide rib.

The opening hole may have a nozzle shape having a diameter reduced toward the cooling passage.

A length to which the guide rib protrudes from the inclined part may be increased in the flow direction of the cooling air.

According an aspect of another exemplary embodiment, there is provided a turbine blade including: a cooling passage configured to be defined by a partition wall which partitions an internal area of the turbine blade; an inlet passage extending from a root part of the turbine blade toward a platform part of the turbine blade and configured to supply cooling air into the cooling passage; and an inclined part configured to be provided inside such that a diameter thereof is reduced from the root part to the platform part, a guide rib being formed on the inclined part to allow the cooling air to form vortexes while moving in a flow direction, wherein a rib may be provided on the platform part to guide a flow direction of cooling air that has passed through the inlet passage.

The rib may extend, in a linear shape, a predetermined length outward in a radial direction of the turbine blade.

The rib may extend, in a curved shape, a predetermined length outward in a radial direction of the turbine blade.

The rib may include a first rib extending a predetermined length and a second rib disposed adjacent to the first rib, wherein the first rib and the second rib may have different extension lengths.

The first rib may linearly extend toward the cooling passage, and the second rib may obliquely extend toward the partition wall.

The inlet passage may include a first inlet passage formed at one side based on the partition wall in a cross-sectional view of the root part and a second inlet passage formed at the other side based on the partition wall, wherein each of the first inlet passage and the second inlet passage may include a single inlet passage.

The first inlet passage and the second inlet passage may have different sizes.

The rib may include a plurality of ribs respectively disposed at position facing each other on an inner bottom surface and an inner top surface of the cooling passage.

### BRIEF DESCRIPTION OF THE DRAWINGS

The above and other aspects will be more clearly understood from the following description of the exemplary embodiments with reference to the accompanying drawings, in which:

FIG. 1 is a sectional view illustrating a turbine apparatus provided with turbine blades in accordance with an exemplary embodiment;

FIG. 2 is a sectional view illustrating a turbine blade in accordance with a first exemplary embodiment;

FIG. 3 is a diagram illustrating an inlet passage provided in the turbine blade in accordance with the first exemplary embodiment;

FIGS. 4 to 6 are diagrams illustrating various examples of the inlet passage in accordance with the first exemplary embodiment;

FIGS. 7 and 8 are diagrams illustrating examples of a guide rib provided in the inlet passage in accordance with the first exemplary embodiment;

FIG. 9 is a diagram illustrating an inlet passage provided in a turbine blade in accordance with a second exemplary embodiment;

FIG. 10 is a diagram illustrating a cross-section of an inlet passage in accordance with the second exemplary embodiment;

FIGS. 11 to 13 are diagrams illustrating various examples of a rib in accordance with the second exemplary embodiment; and

FIG. 14 is a diagram illustrating another example of an inlet passage provided in the turbine blade in accordance with the second exemplary embodiment.

### DETAILED DESCRIPTION

Various modifications may be made to the embodiments of the disclosure, and there may be various types of embodiments. Thus, specific embodiments will be illustrated in drawings, and embodiments will be described in detail in the description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Meanwhile, in case it is determined that in describing the embodiments, detailed explanation of related known technologies may unnecessarily confuse the gist of the disclosure, the detailed explanation will be omitted.

Hereinbelow, exemplary embodiments will be described with reference to the attached drawings. In order to clearly illustrate the disclosure in the drawings, some of the elements that are not essential to the complete understanding of the disclosure may be omitted, and like reference numerals refer to like elements throughout the specification.

The terminology used herein is for the purpose of describing particular embodiments only and is not intended to limit the scope of the disclosure. As used herein, the singular forms “a”, “an”, and “the” are intended to include the plural forms as well unless the context clearly indicates otherwise. Further, the terms “comprises”, “includes”, or “have/has” should be construed as designating that there are such features, regions, integers, steps, operations, elements, components, and/or a combination thereof in the specification, not to exclude the presence or possibility of adding one or more of other features, regions, integers, steps, operations, elements, components and/or combinations thereof.

Further, the terms such as “first”, “second”, etc. may be used to describe various elements, but these elements should not be limited by these terms. These terms are only used to distinguish one element from another element. The use of such ordinal numbers should not be construed as limiting the meaning of the term. For instance, the components associated with such an ordinal number should not be limited in the order of use, placement order, or the like. If necessary, each ordinal number may be used interchangeably.

In addition, the following embodiments are provided so that this disclosure will be thorough and complete, and will fully convey the concept of the invention to those skilled in the art. The drawings are not necessarily to scale and in some instances, proportions may have been exaggerated in order to clearly illustrate features of the exemplary embodiments.

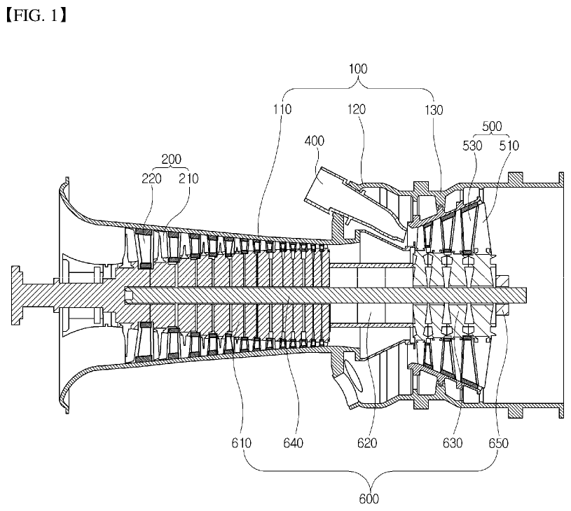

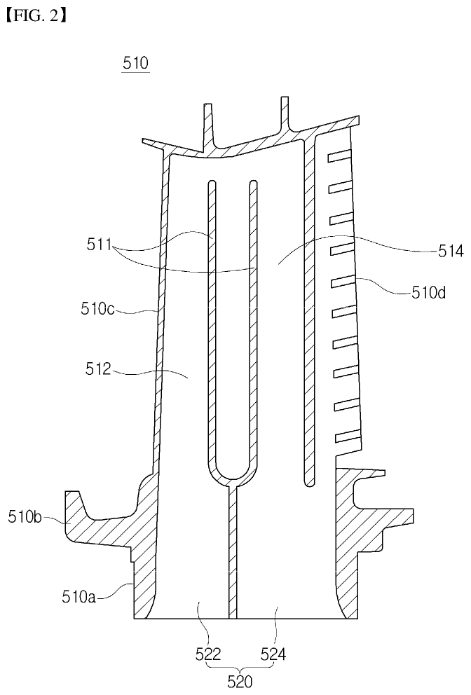

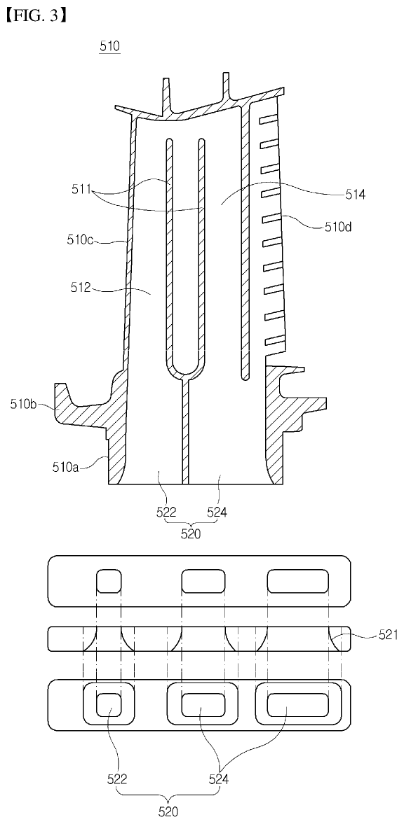

FIG. 1 is a sectional view illustrating a turbine apparatus provided with turbine blades in accordance with an exemplary embodiment. FIG. 2 is a sectional view illustrating a turbine blade in accordance with a first exemplary embodiment. FIG. 3 is a diagram illustrating an inlet passage provided in the turbine blade in accordance with the first exemplary embodiment.

Referring to FIGS. 1 to 3, a gas turbine may include a housing 100, a rotor 600, a compressor 200, a combustor 400, a turbine 500, a generator, and a diffuser. The rotor 600 is rotatably provided in the housing 100. The compressor 200 may receive rotating force from the rotor 600 and compress air drawn into the housing 100. The combustor 400 may mix fuel with air compressed by the compressor 200, and ignite the fuel mixture to generate combustion gas. The turbine 500 may obtain rotating force from the combustion gas generated from the combustor 400, and rotate the rotor 600 using the rotating force. The generator may be interlocked with the rotor 600 to produce electricity. The diffuser may discharge combustion gas that has passed through the turbine 500.

The housing 100 may include a compressor housing 110 which houses the compressor 200, a combustor housing 120 which houses the combustor 400, and a turbine housing 130 which houses the turbine 500.

The compressor housing 110, the combustor housing 120, and the turbine housing 130 are successively arranged in the configuration sequence on the assumption that fluid flows from the left to the right.

The rotor 600 may include a compressor disk 610 housed in the compressor housing 110, a turbine disk 630 housed in the turbine housing 130, and a torque tube 620 housed in the combustor housing 120 to couple the compressor disk 610 and the turbine disk 630.

Also, the rotor 600 may include a tie rod 640 and a fastening nut 650 which are provided to couple the compressor disk 610, the torque tube 620, and the turbine disk 630.

A plurality of compressor disks 610 are arranged along an axial direction of the rotor 600. In other words, the compressor disks 610 form a multi-stage structure.

Each of the compressor disks 610 has a disk shape, and has in an outer circumferential surface thereof a compressor disk slot into which a compressor blade 210 is coupled.

The compressor disk slot may have a fir-tree shape to prevent the compressor blade 210 being undesirably removed from the compressor disk slot in a rotational radial direction of the rotor 600.

The compressor disk 610 and the compressor blade 210 are coupled to each other in a tangential type or an axial type scheme. In the exemplary embodiment, the axial type scheme is used.

A plurality of compressor disk slots may be radially formed and arranged along a circumferential direction of the compressor disk 610. Each of the compressor disk slots may extend in a rotational axis direction.

The turbine disk 630 may be formed in a manner similar to that of the compressor disk 610. A plurality of turbine disks 630 may be arranged along the axial direction of the rotor 600 and have a multi-stage structure.

Each of the turbine disks 630 has a disk shape, and has in an outer circumferential surface thereof a turbine disk slot into which a turbine blade 510 is coupled.

The torque tube 620 may be a torque transmission member configured to transmit the rotating force of the turbine disks 630 to the compressor disks 610. One end of the torque tube 620 may be coupled to one of the plurality of compressor disks 610 that is disposed at the most downstream end with respect to an air flow direction. The other end of the torque tube 620 may be coupled to one of the plurality of turbine disks 630 that is disposed at the most upstream end with respect to a combustion gas flow direction.

A protrusion may be provided on each ends of the torque tube 620. A depression to engage with the corresponding protrusion may be formed in each of the associated compressor disk 610 and the associated turbine disk 630 so that the torque tube 620 may be prevented from rotating relative to the compressor disk 610 or the turbine disk 630.

The torque tube 620 may have a hollow cylindrical shape to allow air supplied from the compressor 200 to flow into the turbine 500 via the torque tube 620.

The torque tube 620 may be formed to resist to deformation, distortion, etc., and designed to be easily assembled or disassembled to facilitate maintenance.

The tie rod 640 may be provided to pass through the plurality of compressor disks 610, the torque tube 620, and the plurality of turbine disks 630. One end of the tie rod 640 may be coupled in one of the plurality of compressor disks 610 that is disposed at the most upstream end with respect to the air flow direction. The other end of the tie rod 640 may protrude, in a direction opposite to the compressor 200, based on one of the plurality of turbine disks 630 that is disposed at the most downstream end with respect to the combustion gas flow direction, and may be coupled to the fastening nut 650.

The fastening nut 650 may compress, toward the compressor 200, the turbine disk 630 that is disposed at the most downstream end to reduce a distance between the compressor disk 610 that is disposed at the most upstream end and the turbine disk 630 that is disposed at the most downstream end. In this case, the plurality of compressor disks 610, the torque tube 620, and the plurality of turbine disks 630 may be compressed in the axial direction of the rotor 600.

Therefore, the plurality of compressor disks 610, the torque tube 620, and the plurality of turbine disks 630 may be prevented from moving in the axial direction or rotating relative to each other.

FIG. 1 illustrates a case in which the single tie rod 640 is provided to pass through central portions of the plurality of compressor disks 610, the torque tube 620, and the plurality of turbine disks 630, but it is understood that this is only an example and other exemplary embodiments are not limited thereto.

For example, separate tie rods 640 may be respectively provided in the compressor 200 and the turbine 500, a plurality of tie rods 640 may be arranged along the circumferential direction, or a combination thereof is also possible.

In accordance with this configuration, opposite ends of the rotor 600 may be rotatably supported by bearings, and one end thereof may be coupled to a driving shaft of the generator.

The compressor 200 may include the compressor blade 210 which rotates along with the rotor 600, and a compressor vane 220 which is fixed in the housing 100 and configured to align the flow of air to be drawn into the compressor blade 210.

A plurality of compressor blades 210 may form a multi-stage structure along the axial direction of the rotor 600. The plurality of compressor blades 210 may be provided in each stage, and may be radially formed and arranged along a rotation direction of the rotor 600.

Each compressor blade 210 may include a planar compressor blade platform part, a compressor blade root part, and a compressor blade airfoil part. The compressor blade root part extends from the compressor blade platform part toward a central side of the rotor 600 with respect to the rotational radial direction of the rotor 600. The compressor blade airfoil part extends from the compressor blade platform part toward a centrifugal side of the rotor 600 with respect to the rotational radial direction of the rotor 600.

The compressor blade platform part may contact with an adjacent compressor blade platform part, and function to maintain a distance between the adjacent compressor blade airfoil parts.

The compressor blade root part has an axial type form which is inserted into the compressor disk slot along the axial direction of the rotor 600.

The compressor blade root part may have a fir-tree shape corresponding to the compressor disk slot.

A size of the compressor disk slot is greater than that of the compressor blade root part so as to facilitate the coupling of the compressor blade root part with the compressor disk slot. In the coupled state, a clearance may be formed between the compressor blade root part and the compressor disk slot.

The compressor blade airfoil part is formed to have an optimized profile according to specifications of the turbine apparatus. The compressor blade airfoil part includes a compressor blade leading edge which is disposed at an upstream side with respect to the air flow direction so that air is incident on the leading edge, and a compressor blade trailing edge which is disposed at a downstream side with respect to the air flow direction so that air exits the trailing edge.

A plurality of compressor vanes 220 may form a multi-stage structure along the axial direction of the rotor 600.

The compressor vanes 220 and the compressor blades 210 are alternately arranged along the air flow direction. A plurality of compressor vanes 220 are provided in each stage, and radially formed and arranged along the rotation direction of the rotor 600.

Each compressor vane 220 may include a compressor vane platform part which is formed in an annular shape along the rotation direction of the rotor 600, and a compressor vane airfoil part which extends from the compressor vane platform part in the rotational radial direction of the rotor 600.

The combustor 400 is configured to mix air supplied from the compressor 200 with fuel and combust the fuel mixture to generate high-temperature and high-pressure combustion gas having high energy, and to increase the temperature of the combustion gas to a heat resistance limit within which the combustor 400 and the turbine 500 can resist heat in an isobaric combustion process.

The turbine 500 is configured in a manner similar to that of the compressor 200, and includes the turbine blade 510 which rotates along with the rotor 600 and a turbine vane 530 which is fixed in the housing 100 and configured to align the flow of combustion gas to be drawn into the turbine blade 510.

A plurality of turbine blades 510 may form a multi-stage structure along the axial direction of the rotor 600. A plurality of turbine blades 510 are provided in each stage, and are radially formed and arranged along the rotating direction of the rotor 600.

Each of the turbine blades 510 may include a cooling passage 512 and 514 defined by a partition wall 511 partitioning an internal area of the turbine blade 510, and an inlet passage 520 extending from a root part 510a of the turbine blade 510 toward a platform part 510b to supply cooling air into the cooling passage 512 and 514. An inclined part 521 which is reduced in diameter from the root part 510a toward the platform part 510b is formed in the inlet passage 520.

In the exemplary embodiment, the structure of the inlet passage 520 through which cooling air is supplied into the cooling passage 512 and 514 is improved, whereby a flow rate loss of the cooling air that is supplied into the cooling passage 512 and 514 may be minimized.

Because the inlet passage 520 has a cross-section extending in a nozzle shape in a flow direction of the cooling air, the cooling air may be reliably supplied into the cooling passage 512 and 514 without a reduction in pressure.

The turbine blade 510 may further include a leading edge 510c which first comes into contact with hot gas and is formed in a front end of the turbine blade 510, and a trailing edge 510d which is formed in a read end of the turbine blade 510. The inlet passage 520 may include a first inlet passage 522 formed at one side based on the partition wall 511 in a cross-sectional view of the root part 510a, and a second inlet passage 524 formed at the other side based on the partition wall 511.

For example, a single first inlet passage 522 may be formed, and a plurality of second inlet passages 524 may be formed. The number of first or second inlet passages 522 or 524 may be changed depending on the internal structure or disposition of the turbine blade 510.

It is understood that the number of first or second inlet passages 522 or 524 is not limited thereto, and may be increased or changed to supply cooling air to an area or position needed to cool the turbine blade 510.

Although the second inlet passage 524 has a lateral length greater than that of the first inlet passage 522, this may also be changed depending on the internal structure or disposition of the turbine blade 510.

The second inlet passage 524 corresponds to the rear end of the turbine blade 510. The temperature distribution of the rear end of the turbine blade 510 may be changed depending on the position due to a round surface shape of the turbine blade 510.

In the turbine blade 510, it is most preferable that cooling air supplied for internal cooling be stably supplied with a minimized flow rate or pressure variation. In the exemplary embodiment, to this end, the second inlet passage 524 extends a lateral length greater than that of the first inlet passage 522.

Therefore, cooling air drawn into the turbine blade 510 through the second inlet passage 524 may be supplied without a reduction in flow rate under conditions of minimized pressure variation, and the efficiency of cooling the turbine blade 510 may be enhanced.

The first inlet passage 522 supplies cooling air at a position adjacent to the leading edge 510c of the turbine blade 510, and the second inlet passage 524 supplies cooling air into an area between the partition wall 511 and the trailing edge 510d.

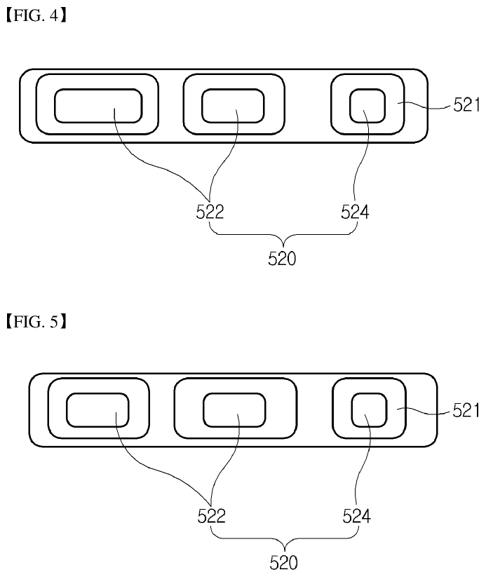

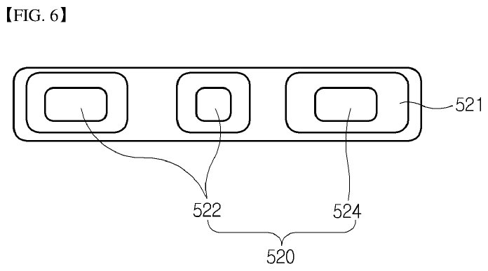

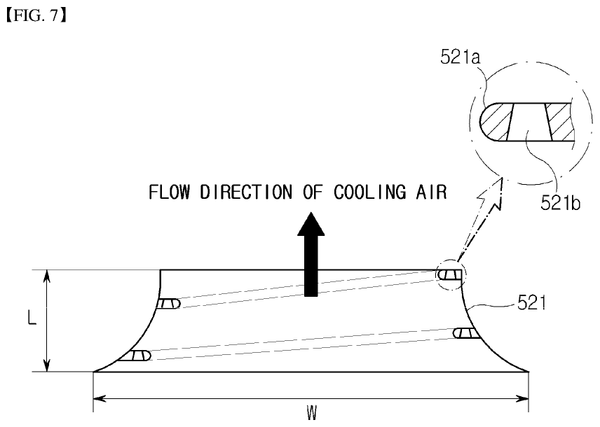

FIGS. 4 to 6 are diagrams illustrating various examples of the inlet passage in accordance with the first exemplary embodiment.

Referring to FIGS. 4 to 6, when the first inlet passage 522 is divided into a plurality of parts, the plurality of parts have different sizes. The turbine blade 510 has a complex internal structure, and areas needed to be cooled vary depending on the position. Therefore, compared to a single first inlet passage structure, cooling air may be easily supplied to positions needed to be cooled in a multi-first-inlet-passage structure.

FIGS. 4 to 6 illustrate cases in which two first inlet passages 522 are provided, but it is understood that this is only an example and other exemplary embodiments are not limited thereto. The number of first inlet passages 522 may be changed, and the positions thereof may also be changed.

For example, the first and second inlet passages 522 and 524 may be disposed such that opening sizes thereof are increased from the first inlet passage 522 to the second inlet passage 524, or vice-versa.

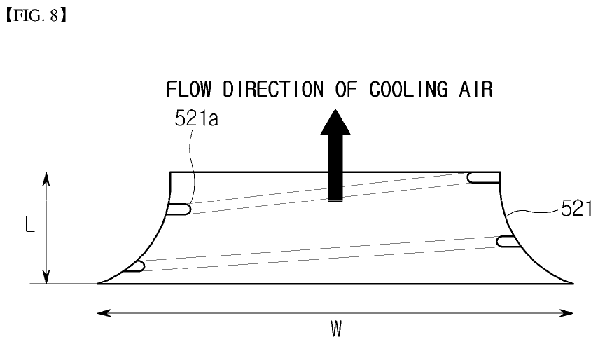

FIGS. 7 and 8 are diagrams illustrating examples of a guide rib provided in the inlet passage in accordance with the first exemplary embodiment.

Referring to FIG. 7, the inlet passage 520 is formed such that a width W extending in a horizontal direction is greater than a length L extending in a vertical direction.

In this case, the supply of a large amount of cooling air in the air flow direction may be facilitated. That is, in the case in which the length L extending in the vertical direction is increased, vortexes may occur due to friction with an inner surface of the inlet passage. Therefore, it is preferable that the width W extending to the horizontal direction is longer than the length L.

Although the width W and the length L of the inlet passage 520 have been described as having predetermined values, the width W and the length L may be changed depending on specifications of the turbine blade 510.

The inclined part 521 is inclined at an angle of 45° or less. The angle corresponds to an angle suitable for making it easy to guide the flow direction of cooling air to a certain position and minimizing vortexes from occurring due to rapid variation in angle.

The inclined part 521 has a bilateral symmetric structure and is inclined at the same angle on opposite sides thereof. Therefore, cooling air may be reliably moved in a direction indicated by the arrow without being focused on a certain position.

The inclined part 521 may include a guide rib 521a which protrudes outward to allow the cooling air to form vortexes while moving in the flow direction.

The guide rib 521a is spirally wound along an inner surface of the inlet passage 520 in a section corresponding to the inclined part 521. Therefore, some of the flow of cooling air forms a flow of cooling air which moves along the inner surface of the inclined part 521, and the other flow of cooling air forms a flow of cooling air which moves along a central portion of the inlet passage 520 that is indicated by the arrow.

When the cooling air moves in a spiral shape, rotating force is generated, whereby a flow of cooling air coming into contact with the inner surface of the inclined part 521 is formed. Furthermore, because cooling air may move on the inclined part 521 without being separated from the inclined part 521, the flow stability of cooling air may be enhanced.

The guide rib 521a may include an opening hole 521b which is open toward the cooling passage 512. The opening hole 521b has a nozzle shape reduced in diameter toward the cooling passage 512. Therefore, the speed and the pressure of cooling air that has passed through the opening hole 521b are increased.

The speed of cooling air that flows through the inlet passage 520 is reduced from the center of the width W toward the inclined part 521. Thus, in the case in which the speed of cooling air on the inclined part 521 is increased by the opening hole 521b, a vortex phenomenon due to separation of flow may be minimized.

Therefore, if cooling air is supplied to the cooling passage 512 via the inlet passage 520, the cooling air may move without a reduction in speed or a large reduction in pressure.

A single opening hole 521b or a plurality of opening holes 521b may be formed. The direction in which the opening hole 521b is open may be the same as that of the foregoing.

Referring to FIG. 8, a guide rib 521a may be formed such that the length L to which the guide rib 521a protrudes from the inclined part 521 is increased in the direction in which the cooling air moves.

In the case in which the length L to which the guide rib 521a protrudes from the inclined part 521 is increased in the flow direction of cooling air, the cooling air may move toward the cooling passage 512 without separation of flow in the section corresponding to the inclined part 521 or a reduction in speed or pressure.

In the inlet passage 520, the guide rib 521a protrudes in a manner different from that of the exemplary embodiment of FIG. 7 so that a phenomenon in which the flow rate of cooling air is reduced from the center of the inlet passage 520 in the width (W) direction toward the inclined part 521 may be minimized.

Furthermore, because the protrusion length of the guide rib 521a is increased such that the flow of cooling air is changed and guided to be more stable, cooling air may be easily supplied to a certain position more needed to be cooled. Therefore, the cooling efficiency may be enhanced.

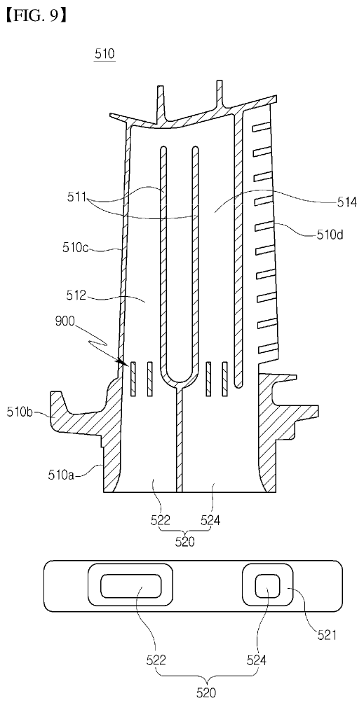

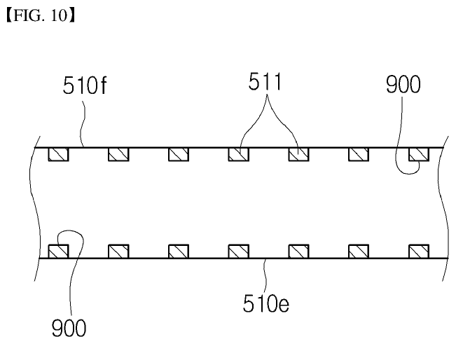

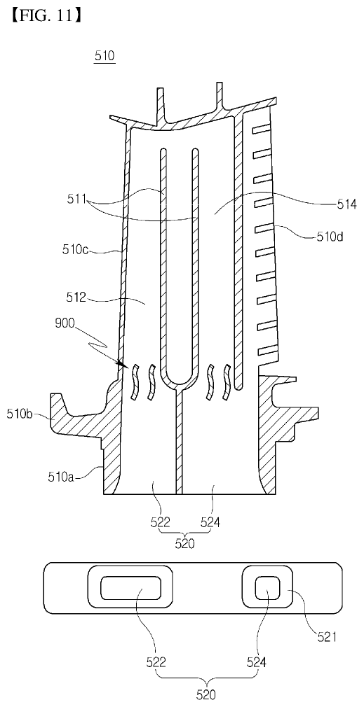

FIG. 9 is a diagram illustrating an inlet passage provided in a turbine blade in accordance with a second exemplary embodiment. FIG. 10 is a diagram illustrating a cross-section of an inlet passage in accordance with the second exemplary embodiment.

Referring to FIGS. 9 and 10, the turbine blade 510 may include a cooling passage 512 and 514, an inlet passage 520, and an inclined part 521. The cooling passage 512 and 514 is defined by a partition wall 511 which partitions an internal area of the turbine blade 510. The inlet passage 520 extends from a root part 510a of the turbine blade 510 toward a platform part 510b and is configured to supply cooling air to the cooling passage 512 and 514. The inclined part 521 is formed inside such that a diameter thereof is reduced from the root part 510a to the platform part 510b. The inclined part 521 is provided with a guide rib on an inner surface of the inclined part 521 to allow the cooling air to form vortexes while moving in a flow direction. A rib 900 is provided on the platform part 510b to guide the flow direction of cooling air that has passed through the inlet passage 520.

In the second exemplary embodiment, the rib 900 is provided on the platform part 510b to reliably guide once more the movement of cooling air passing through the inlet passage 520.

In the turbine blade 510, cooling air that has passed through the inlet passage 520 is drawn into the cooling passage 512 and 514 defined by the partition wall 511. While the cooling air flows along the cooling passage 512 and 514 and then moves to the trailing edge 510d, the cooling air cools the turbine blade 510.

In the second exemplary embodiment, before the cooling air is supplied into the cooling passage 512 and 514, the flow direction, the speed, and the pressure of cooling air are additionally adjusted, whereby cooling efficiency depending on the position of the turbine blade 510 may be enhanced.

To this end, the rib 900 extends, in a linear shape, a predetermined length outward in a radial direction of the turbine blade 510.

It is understood that the number of ribs 900 is not limited to FIG. 9, and may be changed. The length and the width of each rib 900 may also be changed. Furthermore, the ribs 900 may be provided at positions facing each other on an inner bottom surface 510e and an inner top surface 510f of the platform part 510b.

For example, in the case in which the ribs 900 are disposed to face each other, the flow of cooling air is guided along the ribs 900 regardless of the position in the platform part 510b.

Therefore, cooling air reliably moves toward the cooling passage 512 and 514 without a reduction in speed or a loss in flow rate.

FIGS. 11 to 13 are diagrams illustrating various examples of a rib in accordance with the second exemplary embodiment.

Referring to FIG. 11, the rib 900 extends, in a curved shape, a predetermined length outward in the radial direction of the turbine blade 510.

Because the curvature and the shape of the rib 900 may be changed in various ways, the flow stability of cooling air may be secured, and variation in flow rate and pressure of cooling air may be minimized.

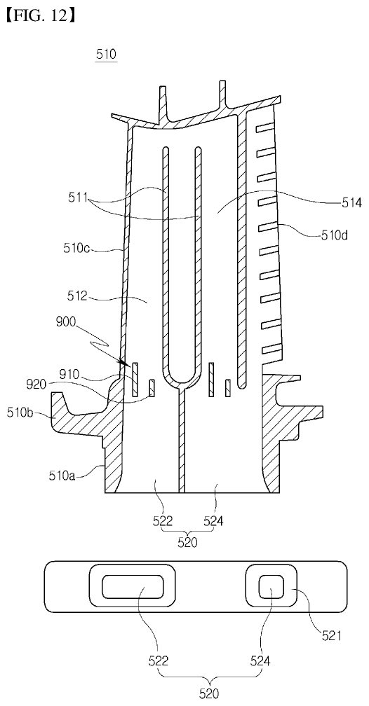

Referring to FIG. 12, the rib 900 may include a first rib 910 extending a predetermined length, and a second rib 920 disposed adjacent to the first rib 910. The first rib 910 and the second rib 920 have different lengths.

It is understood that the lengths of the first and second ribs 910 and 920 are not limited to FIG. 12, and may be changed in various ways.

The lengths to which the first rib 910 and the second rib 920 extend are determined by considering an internal temperature distribution of the cooling passage 512 and 514. The first rib 910 and the second rib 920 may guide the flow of cooling air in the platform part 510b, thus securing the flow stability of cooling air, and minimizing a loss of hydraulic pressure.

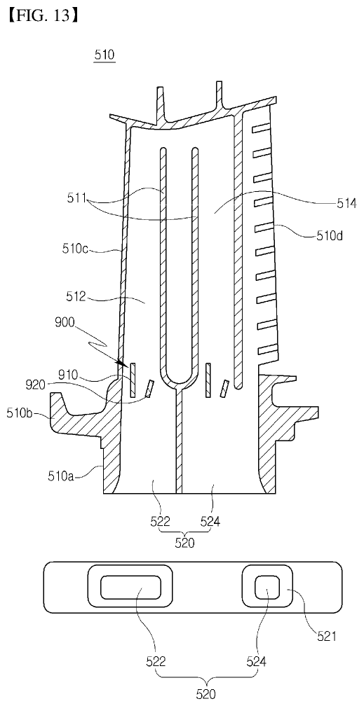

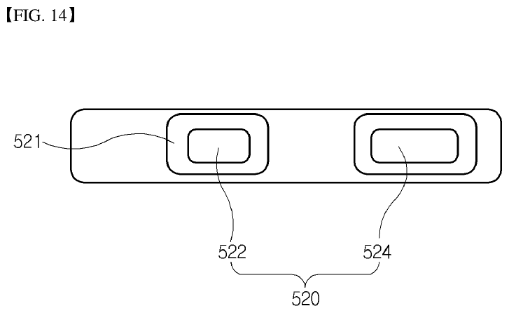

Referring to FIG. 13, the first rib 910 may linearly extend toward the cooling passage 512, and the second rib 920 may obliquely extend toward the partition wall 511.

The first rib 910 guides the flow of cooling air in the 12 o'clock direction, and the second rib 920 guides the flow of cooling air toward the partition wall 511. Thus, the flow of cooling air may be efficiently guided toward certain positions, thereby improving the efficiency of cooling the turbine blade 510.

FIG. 14 is a diagram illustrating another example of an inlet passage provided in the turbine blade in accordance with the second exemplary embodiment.

Referring to FIG. 14, the inlet passage 520 may include a first inlet passage 522 formed at one side based on the partition wall 511 in a cross-sectional view of the root part 510a, and a second inlet passage 524 formed at the other side based on the partition wall 511. Here, a single first inlet passage 522 and a single second inlet passage 524 are formed to enhance convenience in production, secure a stable flow rate, and improve the efficiency of cooling the turbine blade 510.

The first inlet passage 522 and the second inlet passage 524 may have different sizes. Therefore, cooling air may be reliably supplied to an area having a high flow rate.

Therefore, cooling air may be efficiently supplied to a portion of the turbine blade 510 that is highly required to be cooled.

One or more exemplary embodiments may provide a turbine blade in which an inlet passage is formed in a root part such that flow rate loss in a platform part is reduced, whereby the flow stability in the turbine blade may be enhanced.

Furthermore, one or more exemplary embodiments may provide a turbine blade having an inlet passage capable of minimizing loss in flow rate and hydraulic pressure of cooling air supplied into the turbine blade so that the efficiency of cooling the turbine blade can be enhanced.

While exemplary embodiments have been described with reference to the accompanying drawings, it will be understood by those skilled in the art that various modifications in form and details may be made therein without departing from the spirit and scope as defined in the appended claims. Therefore, the description of the exemplary embodiments should be construed in a descriptive sense and not to limit the scope of the claims, and many alternatives, modifications, and variations will be apparent to those skilled in the art.

Therefore, the description of the exemplary embodiments should be construed in a descriptive sense and not to limit the scope of the claims, and many alternatives, modifications, and variations will be apparent to those skilled in the art.

What is claimed is:

1. A turbine blade comprising:
a cooling passage configured to be defined by a partition wall which partitions an internal area of the turbine blade; and
an inlet passage extending from a root part of the turbine blade toward a platform part of the turbine blade and configured to supply cooling air into the cooling passage,
wherein an inclined part having a diameter reduced from the root part toward the platform part is formed in the inlet passage.

2. The turbine blade according to claim 1, wherein the turbine blade further comprising:
a leading edge formed on a front end of the turbine blade so that the leading edge first comes into contact with hot gas; and
a trailing edge formed on a rear end of the turbine blade, and
wherein the inlet passage comprises:
a first inlet passage formed at one side based on the partition wall in a cross-sectional view of the root part; and
a second inlet passage formed at the other side based on the partition wall.

3. The turbine blade according to claim 2, wherein the inlet passage comprises a single first inlet passage and a plurality of second inlet passages.

4. The turbine blade according to claim 2, wherein the second inlet passage extends a length greater than a length of the first inlet passage in a lateral direction.

5. The turbine blade according to claim 3, wherein the plurality of second inlet passages have different sizes.

6. The turbine blade according to claim 2, wherein the inlet passage has a width (W) extending in a horizontal direction and a length (L) extending in a vertical direction, and the width (W) is greater than the length (L).

7. The turbine blade according to claim 1, wherein the inclined part is inclined at an angle of 45° or less.

8. The turbine blade according to claim 1, wherein a guide rib protruding outward is provided on the inclined part to allow the cooling air to form vortexes while moving in a flow direction.

9. The turbine blade according to claim 8, wherein the guide rib is spirally wound along an inner surface of the inclined part.

10. The turbine blade according to claim 8, wherein an opening hole that is open toward the cooling passage is formed in the guide rib.

11. The turbine blade according to claim 10, wherein the opening hole has a nozzle shape having a diameter reduced toward the cooling passage.

12. The turbine blade according to claim 8, wherein a length to which the guide rib protrudes from the inclined part is increased in the flow direction of the cooling air.

13. A turbine blade comprising:
a cooling passage configured to be defined by a partition wall which partitions an internal area of the turbine blade;
an inlet passage extending from a root part of the turbine blade toward a platform part of the turbine blade and configured to supply cooling air into the cooling passage; and
an inclined part configured to be provided inside such that a diameter thereof is reduced from the root part to the platform part, a guide rib being formed on the inclined part to allow the cooling air to form vortexes while moving in a flow direction,
wherein a rib is provided on the platform part to guide a flow direction of cooling air that has passed through the inlet passage.

14. The turbine blade according to claim 13, wherein the rib extends, in a linear shape, a predetermined length outward in a radial direction of the turbine blade.

15. The turbine blade according to claim 13, wherein the rib extends, in a curved shape, a predetermined length outward in a radial direction of the turbine blade.

16. The turbine blade according to claim 13, wherein the rib comprises:
a first rib extending a predetermined length; and
a second rib disposed adjacent to the first rib,
wherein the first rib and the second rib have different extension lengths.

17. The turbine blade according to claim 16, wherein the first rib linearly extends toward the cooling passage, and the second rib obliquely extends toward the partition wall.

18. The turbine blade according to claim 16, wherein the inlet passage comprises:
a first inlet passage formed at one side based on the partition wall in a cross-sectional view of the root part; and
a second inlet passage formed at the other side based on the partition wall,
wherein each of the first inlet passage and the second inlet passage comprises a single inlet passage.

19. The turbine blade according to claim 18, wherein the first inlet passage and the second inlet passage have different sizes.

20. The turbine blade according to claim 16, wherein the rib comprises a plurality of ribs respectively disposed at position facing each other on an inner bottom surface and an inner top surface of the cooling passage.
